(19) United States
(12) Patent Application Publication
(10) Pub. No.: US 2015/0106574 A1
(43) Pub. Date: Apr. 16, 2015

(54) Performing Processing Operations for Memory Circuits using a Hierarchical Arrangement of Processing Circuits

(71) Applicant: Advanced Micro Devices, Inc., Sunnyvale, CA (US)

(72) Inventors: Nuwan S. Jayasena, Sunnyvale, CA (US); Anton Chernoff, Littleton, MA (US)

(73) Assignee: Advanced Micro Devices, Inc., Sunnyvale, CA (US)

(21) Appl. No.: 14/053,957

(22) Filed: Oct. 15, 2013

(51) Int. Cl. G06F 3/06

(52) U.S. Cl. CPC G06F 3/0659; G06F 3/0604; G06F 3/0683; G06F 2003/0697
USPC 711/154

(57) ABSTRACT

The described embodiments include a computing device that comprises at least one memory die having memory circuits and memory die processing circuits, and a logic die coupled to the at least one memory die, the logic die having logic die processing circuits. In the described embodiments, the memory die processing circuits are configured to perform memory die processing operations on data retrieved from or destined for the memory circuits and the logic die processing circuits are configured to perform logic die processing operations on data retrieved from or destined for the memory circuits.

### GOVERNMENT LICENSE RIGHTS

This invention was made with Government support under prime contract number DE-AC52-07NA27344, subcontract number B600716 awarded by DOE. The Government has certain rights in this invention.

### BACKGROUND

1. Field

The described embodiments relate to computing devices. More specifically, the described embodiments relate to performing processing operations for memory circuits using a hierarchical arrangement of processing circuits in a computing device.

2. Related Art

Virtually all modern computing devices include some form of memory that is used to store data and instructions that are used by entities in the computing device for performing computational operations. For example, one common configuration of computing devices includes a central processing unit (CPU) and a main memory, with the main memory storing instructions and data used by the CPU for performing computational operations. Another common configuration of computing devices includes a graphics processing unit (GPU) and graphics memory, with the graphics memory storing instructions and data used by the GPU for performing computational operations. Generally, when performing computational operations, an entity retrieves instructions and/or data from the memory and executes the instructions and/or uses the data to perform computational operations. If there are any results from the computational operations, the entity then writes the results from computational operations back to the memory. However, because the transfer of instructions and data between entities in the computing device and the memory typically occurs at a significantly slower rate than the rate at which the entities are able to use instructions and data when performing computational operations, retrieving instructions and data and writing back results slows the rate at which entities are able to perform computational operations.

### BRIEF DESCRIPTION OF THE FIGURES

FIG. 1 presents a block diagram illustrating a computing device in accordance with some embodiments.

FIG. 2 presents a block diagram illustrating a processor die in accordance with some embodiments.

FIG. 3 presents a block diagram illustrating a logic die in accordance with some embodiments.

FIG. 4 presents a block diagram illustrating a memory die in accordance with some embodiments.

FIG. 5 presents a block diagram illustrating multiple memory circuits and memory die processing circuits in accordance with some embodiments.

FIG. 6 presents a block diagram illustrating an internal arrangement of functional blocks in a memory die in accordance with some embodiments.

FIG. 7 presents a block diagram illustrating an arrangement of dies in accordance with some embodiments.

FIG. 8 presents a flowchart illustrating a process for assembling an arrangement of dies in accordance with some embodiments.

FIG. 9 presents a flowchart illustrating a process for sending a command to a controller in a memory die from a processor in accordance with some embodiments.

FIG. 10 presents a flowchart illustrating a process for receiving a command in a controller in a memory die in accordance with some embodiments.

FIG. 11 presents a flowchart illustrating a process for handling a command in a logic die in accordance with some embodiments.

Throughout the figures and the description, like reference numerals refer to the same figure elements.

### DETAILED DESCRIPTION

The following description is presented to enable any person skilled in the art to make and use the described embodiments, and is provided in the context of a particular application and its requirements. Various modifications to the described embodiments will be readily apparent to those skilled in the art, and the general principles defined herein may be applied to other embodiments and applications without departing from the spirit and scope of the described embodiments. Thus, the described embodiments are not limited to the embodiments shown, but are to be accorded the widest scope consistent with the principles and features disclosed herein.

### Overview

The described embodiments include computing device with a memory implemented on at least one memory die (i.e., a semiconductor die that includes memory circuits such as dynamic random-access memory (DRAM)). The memory die also includes memory die processing circuits that are configured to perform processing operations on data retrieved from and/or destined for the memory circuits. In addition, the computing device includes at least one logic die coupled to the memory die. The logic die includes logic die processing circuits that are configured to perform processing operations on data retrieved from and/or destined for the memory circuits. In some embodiments, the processing operations performed in the processing circuits in the memory dies and the logic die are hierarchically arranged, with the processing circuits in the memory die performing less complex and/or higher bandwidth computational operations on data retrieved from or destined for the memory circuits (i.e., without sending the data off the memory die for performing the computational operations) and with the logic circuits performing more complex and/or lower bandwidth computational operations on data retrieved from or destined for the memory circuits.

Note that “bandwidth” as used here relates to a rate of data transfer (e.g., a rate at which data is transferred between functional blocks) as an operation is performed, and thus the amount of data that would be retrieved from the memory circuits and transferred over a communication link between the memory die and the logic die if an operation was to be performed in the logic die in a given time. Generally, high-bandwidth operations are operations that are performed for more than a specified amount of data (e.g., X bytes, etc.) in a given amount of time (e.g., Y ms), whereas low-bandwidth operations are performed for less than the specified amount of data in the given amount of time. In this example, X and Y are values that would be established in accordance with available bandwidth between functional blocks, bandwidth consumption thresholds, and/or other bounds.

In some embodiments, the computing device also includes a processor die coupled to the logic die and the memory die. The processor die includes at least one fully-featured processor such as a central processing unit core (CPU core), a graphics processing unit core (GPU core), etc. In these embodiments, the processor is part of the hierarchical arrangement of processing circuits in the logic die and the memory die, with the hierarchy comprising the processor die at a highest level, then the logic die, and finally the memory die at the lowest level. Within the hierarchy, the processor performs general processing operations on data retrieved from and/or destined for the memory circuits. In some embodiments, the processor also sends commands that indicate computational operations to be performed on data retrieved from or destined for the memory circuits by one or both of the processing circuits in the memory die and the logic die.

Using the processing circuits in the above-described hierarchical arrangement, the described embodiments can perform at least some computational operations on data retrieved from or destined for the memory circuits in the processing circuits on the memory die and/or the logic die. By performing these operations in the processing circuits in the memory die and/or the logic die, these embodiments can avoid the need for the processor to retrieve corresponding data from the memory circuits, perform the operations, and write results (if any) back to the memory circuits. That is, the memory die processing circuits and the logic die processing circuits can be used to offload a portion of the operations from the processor. This offloading is beneficial because, in comparison to existing computing devices, the processor is freed to perform other computational operations and a communication link between the processor, the logic die, and/or the memory die may carry less traffic, which generally improves the performance and energy efficiency of the computing device.

### Computing Device

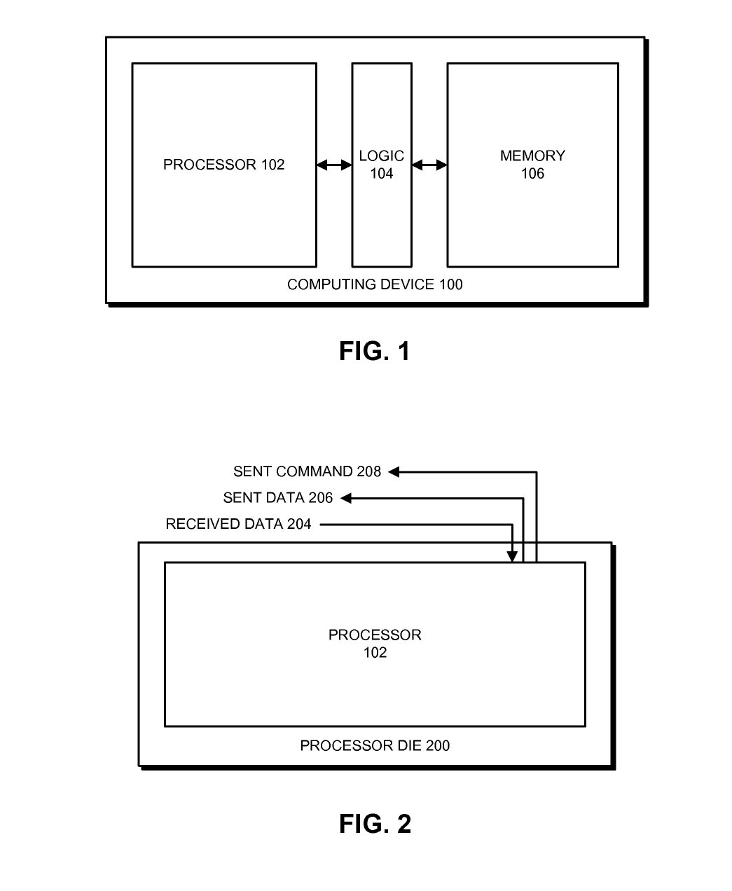

FIG. 1 presents a block diagram illustrating computing device 100 in accordance with some embodiments. As can be seen in FIG. 1, computing device 100 includes processor 102, logic 104, and memory 106. Processor 102 is a functional block such as a central processing unit (CPU), a graphics processing unit (GPU), an application-specific integrated circuit (ASIC), a microcontroller, a programmable logic device, and/or an embedded processor that is configured to perform general computational operations in computing device 100. For example, processor 102 can include one or more instruction execution pipelines, caches, input-output units, control circuits, event processing circuits, and/or other circuits, each of which performs a corresponding portion of the computational operations. In some embodiments, processor 102 is a fully-featured processor that is configured to support many, if not all, of a set of operations for at least one instruction set architecture. In these embodiments, processor 102 includes general-purpose processing circuits that can be configured via executing instructions to perform operations for the instruction set architecture.

Logic 104 is a functional block that includes circuits for performing operations on data retrieved from and/or destined for memory circuits in memory 106. Generally, logic 104 may include any type of circuits, from fully-featured processing circuits that can perform many, if not all, of the operations for one or more corresponding instruction set architectures, to processing circuits of more limited capabilities and/or dedicated processing circuits that are configured to perform one or more operations. In some embodiments, logic 104 is configured to perform a small set of operations efficiently (i.e., dedicated and/or purpose-specific circuits for performing operations from the set of operations may be optimized for speed, energy efficiency, simultaneous data capacity, etc.).

Memory 106 is a functional block that is configured to store data and instructions for use in computing device 100. Memory 106 includes memory circuits such as DRAM and/or other types of memory circuits. In some embodiments, memory 106 is a main memory in computing device 100. Although not shown in FIG. 1, as is described in more detail below, in the described embodiments, memory 106 includes processing circuits for performing computational operations on data retrieved from and/or destined to the memory circuits.

Processor 102, logic 104, and memory 106 are communicatively coupled to one another via one or more signal lines such as busses, signal lines, etc. (the signal lines are represented in FIG. 1 using double-headed arrows between the functional blocks). The busses, signal lines, etc. are used to transfer instructions and data and commands between the functional blocks as described herein.

Although embodiments are described where computing device includes processor 102, logic 104, and memory 106, some embodiments include less functional blocks. For example, in some embodiments, processor 102 is not included and/or is not coupled as shown. In these embodiments, logic 104 may perform various computational operations on data retrieved from or destined for memory circuits. In some of these embodiments, processor 102 may be coupled to memory 106 (e.g., to provide access to instructions and data stored in memory 106), but may not be coupled to logic 104. Thus, logic 104 may be coupled to memory 106 without also being coupled to processor 102. As another example, in some embodiments, one or more additional logic functional blocks can be coupled between processor 102 and/or logic 104 and memory 106.

Although an embodiment is described with a single processor, processor 102, some embodiments include a different number and/or arrangement of processors. For example, some embodiments have two, five, eight, or another number of processors. In these embodiments, zero or more of the processors may be coupled to logic 104 (i.e., in some embodiments zero or more of the processors may be coupled to memory 106 without also being coupled to logic 104—as is described above). Additionally, embodiments that include more than one processor may also include one or more additional logic functional blocks such as logic 104. For example, some embodiments include a logic functional block coupled to each of a set of processors in computing device 100. Generally, the described embodiments can use any arrangement of processors, logic functional blocks, and memories that can perform the operations herein described.

Moreover, computing device 100 is simplified for illustrative purposes. In some embodiments, computing device 100 includes additional functional blocks, mechanisms, etc. for performing the operations herein described and other operations. For example, computing device 100 may include power systems (batteries, plug-in power sources, etc.), caches, mass-storage devices such as disk drives or large semiconductor memories, media processors, input-output mechanisms, communication mechanisms, networking mechanisms, display mechanisms, etc.

Computing device 100 may be included in or may be any of various electronic devices. For example, computing device may be included in or be a desktop computer, a server computer, a laptop computer, a tablet computer, a smart phone, a toy, an audio/visual device (e.g., a set-top box, a television, a stereo receiver, etc.), a piece of network hardware, a controller, and/or another electronic device or combination of devices.

### Integrated Circuit Dies

In some embodiments, processor 102, logic 104, and memory 106 are each implemented using one or more integrated circuit dies (or, more simply, “dies”). In other words, processor 102, logic 104, and memory 106 are implemented as semiconductor integrated circuits that are fabricated on one or more corresponding dies. In some embodiments, the dies on which processor 102, logic 104, and memory 106 are coupled together as shown in FIG. 1.

FIG. 2 presents a block diagram illustrating processor die 200 in accordance with some embodiments. Generally, as can be seen in FIG. 2, processor 102 is implemented on processor die 200. As described above, processor 102 is a functional block that is configured to perform general computational operations. Processor 102 is configured to receive data 204 (e.g., input data for computational operations) from memory die 400 and/or logic die 300, and is configured to send data 206 (e.g., results of computational operations) to logic die 300 and/or memory die 400. In addition, in some embodiments, processor 102 is configured to send command 208 to one or both of controller 304 or controller 406, the command 208 causing the receiving controller to cause corresponding processing circuits to perform one or more operations on data retrieved from and/or destined for memory circuits 402.

Note that “data” as used herein includes any data that can be retrieved from and/or sent to memory circuits 402 (i.e., can be any number of bytes and in any configuration permitted by sending and receiving functional blocks, etc.). In addition, “command” as used herein includes any type and/or format of command that is configured to cause one or more of controllers 304 and controller 406 to perform a corresponding operation. Both data and commands are described in more detail below.

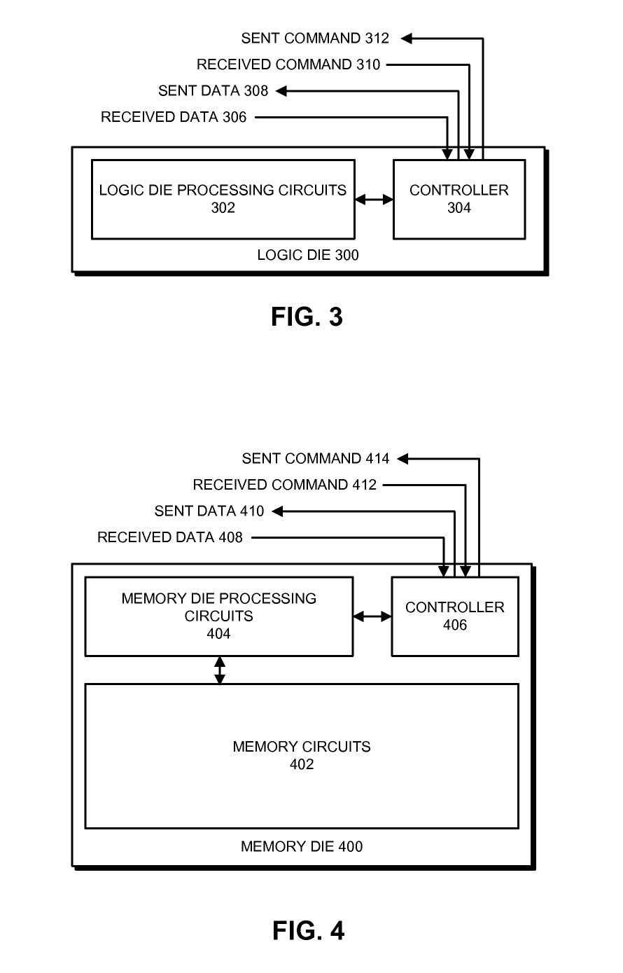

FIG. 3 presents a block diagram illustrating logic die 300 in accordance with some embodiments. Generally, logic 104 is implemented on logic die 300. As can be seen in FIG. 3, logic die 300 includes logic die processing circuits 302 and controller 304. Logic die processing circuits 302 is a functional block configured to perform operations on data retrieved from and/or destined for memory circuits in memory 106. Depending on the embodiment, logic die processing circuits 302 may be configured to perform operations of various levels of complexity using either dedicated circuits or general-purpose circuits via program code. For example, depending on the embodiment, logic die processing circuits 302 can perform operations from simple operations such as bitwise inverts, bitwise shifts, simple logical operations (AND, OR, etc.), simple mathematical operations (simple adds or subtracts, etc.) to more complex operations, such as multiplication/division, complex mathematical or logical operations, and/or other operations. As described above, in some embodiments, logic die processing circuits 302 are fully-featured processing circuits that can perform many, if not all, of the operations for one or more corresponding instruction set architectures. In some embodiments, logic die processing circuits 302 are configured to perform simultaneous-instruction multiple-data (SIMD) operations, vector operations, and/or other parallel-processing operations to enable the simultaneous processing of separate portions of data.

Controller 304 is a functional block that is configured to control the performance of operations on data retrieved from and/or destined for memory circuits 402 (“received data”). For example, in some embodiments, controller 304 receives, from one or more of processor 102, controller 406, and/or another functional block in computing device 100, commands 310 associated with received data 306. Based on the commands, controller 304 causes logic die processing circuits 302 to perform one or more operations on the received data to generate result data. The result data from the operations is then sent as sent data 308 to a destination (e.g., processor die 200 or memory die 400).

FIG. 4 presents a block diagram illustrating memory die 400 in accordance with some embodiments. Generally, memory 106 is implemented on memory die 400. As can be seen in FIG. 4, memory die 400 includes memory circuits 402, memory die processing circuits 404, and controller 406. Memory circuits 402 is a functional block that includes memory circuits, e.g., DRAM circuits and/or another type of memory circuits, that are used for storing instructions and data, as well as circuits for accessing and otherwise handling data in the memory circuits. In some embodiments, memory circuits 402 are configured so that data is read from memory circuits 402 in rows and/or columns, with each read row and/or column containing a specified portion of the memory, e.g., 4096 bytes, 8192 bytes, etc. In these embodiments, the operations described below as being performed by memory die processing circuits 404 can be performed on some or all of the data from a row and/or a column of memory, including being performed as a parallel-processing operation such as a vector operation, a simultaneous-instruction multiple-data (SIMD) operation, and/or another parallel-processing operation that enables the simultaneous processing of the data.

Memory die processing circuits 404 is a functional block that is configured to perform computational operations on data retrieved from and/or destined for memory circuits 402. Generally, memory die processing circuits 404 are configured to perform a specified set of operations using either dedicated circuits or general-purpose circuits via program code. For example, memory die processing circuits 404 may perform operations such as bitwise inverts, bitwise shifts, logical operations (AND, XOR, etc.), mathematical operations (additions, subtractions, etc.), data reductions, high-bandwidth operations (i.e., operations that are associated with higher rates of data transfer, e.g., more than X bytes in Y ms, etc.), and/or other operations. As described above, in some embodiments, memory die processing circuits 404 include circuits configured to perform parallel-processing operations such as vector operations, SIMD operations, and/or other parallel-processing operations.

Controller 406 is a functional block that is configured to control the performance of operations on data retrieved from and/or destined for memory circuits 402 (“received data”). For example, in some embodiments, controller 406 receives, from one or more of processor 102, controller 304, and/or another functional block in computing device 100, commands 412 associated with received data 408 and/or data to be retrieved from memory circuits 402. Based on commands 412, controller 406 causes memory die processing circuits 404 to perform one or more operations on the received/retrieved data to generate result data. The result data is then sent as sent data 410 to a destination (e.g., processor 102 or logic 104) and/or is stored in memory circuits 402.

In some embodiments, one or both of controller 406 and memory die processing circuits 404 are implemented in the same process technology as memory circuits 402. For example, if semiconductor fabrication process A is used for memory circuits 402, semiconductor fabrication process A is also used to fabricate controller 406 and memory die processing circuits 404.

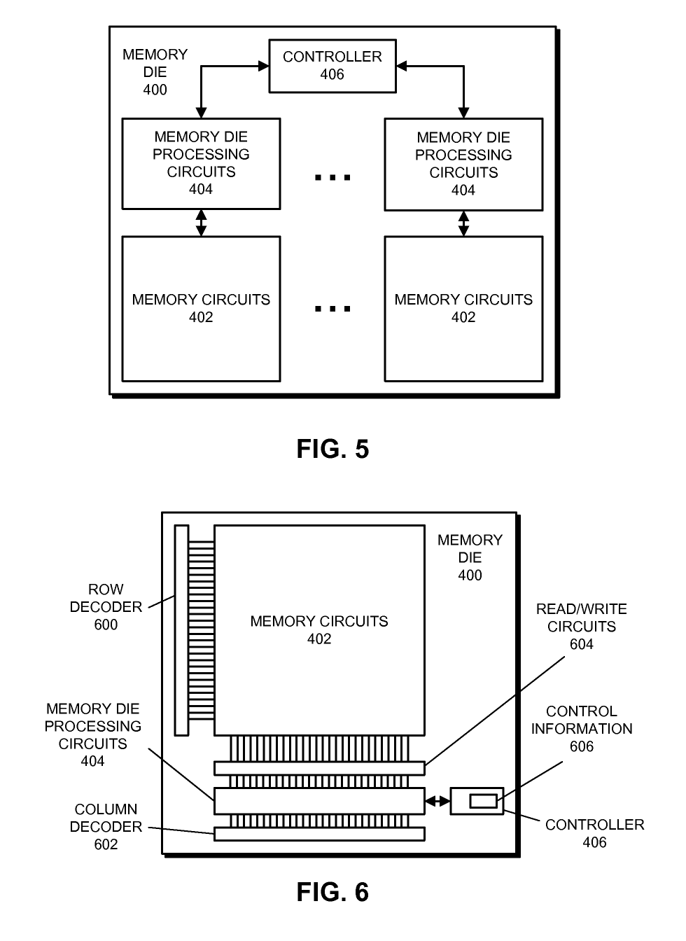

In some embodiments, memory die 400 includes more than one of memory circuits 402 and/or memory die processing circuits 404. FIG. 5 presents a block diagram illustrating multiple memory circuits and memory die processing circuits in accordance with some embodiments. As can be seen in FIG. 5, memory die 400 includes two or more (as represented by the ellipsis) of memory circuits 402. For example, memory die 400 may include multiple separate memory arrays that each comprise corresponding memory circuits 402. In these embodiments, each instance of memory circuits 402 may be associated with separate memory die processing circuits 404. The separate memory die processing circuits may be configured to perform similar operations for data retrieved from and/or destined for the corresponding memory circuits 402 as the operations described above for FIG. 4.

In some embodiments, with regard to the processing that is to be performed in the corresponding processing circuits, logic die 300 and memory die 400 are arranged hierarchically from memory die processing circuits 404 to logic die processing circuits 302 to processor 102. For example, logic die processing circuits 302 may be configured to perform more complex and/or lower bandwidth operations (i.e., operations that have less than specified rates of data transfer from memory circuits 402) on data retrieved from and/or destined for memory circuits 402 (“received data”), and memory die processing circuits 404 may be configured to perform less complex and/or higher-bandwidth operations on received data. In some embodiments, in addition to memory die processing circuits 404 and logic die processing circuits 302, processor 102 is configured to perform a fully-featured set of operations on received data, which may or may not be more operations than logic die processing circuits 302 are configured to perform (i.e., in some embodiments logic die processing circuits 302 support many, if not all, of a fully-featured set of operations).

In some embodiments, processor 102 is configured to generate sent command 208 which is received by one of logic die 300 (as received command 310) or memory die 400 (as received command 412) that cause one of logic die processing circuits 302 or memory die processing circuits 404 to perform one or more corresponding operations on data retrieved from and/or destined for memory circuits 402. For example, in some embodiments, a hardware monitoring mechanism and/or an operating system, an application, a just-in-time compiler, and/or other software being executed by processor 102 (generally, “software”) may detect that an operation is to be performed for data retrieved from and/or destined for memory circuits 402 and may further determine that logic die processing circuits 302 and/or memory die processing circuits 404 are configured to perform the operation. The hardware monitoring mechanism and/or software may generate one or more commands to be sent to controller 304 and/or controller 406 that cause the corresponding operations to be performed by logic die processing circuits 302 and/or memory die processing circuits 404, respectively. For example, the hardware monitoring mechanism and/or software may determine that a given value is to be added to data retrieved from memory circuits 402 and may send command 412 to controller 406 to cause memory die processing circuits 404 to perform the addition on the data. In this case, the command may indicate that the addition operation is to be performed (via an opcode, an operation reference, a program counter, etc.), may identify the data, and may include other information about the command (e.g., a priority, a correctness verification value, etc.).

In some embodiments, one or both of controller 304 and controller 406 is configured to send commands to other functional blocks in computing device 100. For example, in some embodiments, controller 304 is configured to send commands 312 to controller 406, the commands configured to cause memory die processing circuits 404 to perform corresponding operations. In these embodiments, command 310 received by controller 304, e.g., from processor 102, may include commands to cause the performance of operations that are to be performed in memory die processing circuits 404 (e.g., that logic die processing circuits 302 may be able to perform, but which are more efficiently performed in memory die processing circuits 404 or are otherwise to be performed in memory die processing circuits 404). For such commands 310, in some embodiments, controller 304 is configured to extract/generate corresponding commands for controller 304 and send the extracted commands as command 312 to controller 406 (which controller 406 receives as command 412). In a similar way, in some embodiments, controller 406 is configured to send command 414 to controller 304 to cause controller 304 to perform corresponding operations.

Although various functional blocks are used to describe processor die 200, logic die 300, and memory die 400 (collectively, “the dies”), in some embodiments, different and/or more functional blocks may be present. For example, in some embodiments, some or all of the dies may include functional blocks for handling operations of the die (e.g., power handling, error handling, startup and shutdown, etc.). Generally, the dies include sufficient functional blocks to perform the operations herein described and/or other operations of the dies.

### Internal Arrangement of a Memory Die and a Logic Die

FIG. 6 presents a block diagram illustrating an internal arrangement of functional blocks in memory die 400 in accordance with some embodiments. As can be seen in FIG. 6, memory die 400 includes memory circuits 402, memory die processing circuits 404, and controller 406, which are described above. Memory die 400 also includes row decoder 600, column decoder 602, read/write circuits 604, and control information 606.

Row decoder 600, column decoder 602, and read/write circuits 604 are generally functional blocks used for performing reads and writes of data in memory circuits 402. More specifically, row decoder 600 and column decoder 602 are used for addressing/selecting particular cells (each cell being used to store data) in memory circuits 402 and read/write circuits 604 are used for reading and writing data to addressed/selected cells in memory circuits 402.

Control information 606 in controller 406 includes a memory element such as a register, a memory circuit, or programmable circuit (e.g., field-programmable gate array or FPGA) that is configured to hold commands (e.g., bit sequences representing commands, opcodes, program counters, locations in memory circuits 402 where commands are stored, and/or other forms of commands) and/or information derived from, about, or related to commands received by controller 406. The information in control information 606 is used by controller 406 to control the performance of operations by memory die processing circuits 404 on data retrieved from and/or destined for memory circuits 402. For example, in some embodiments, memory die processing circuits 404 are configured to selectively perform two or more operations on the data (e.g., an add operation, a matrix operation, etc.) and the information in control information 606 determines the particular operation that is to be performed. In some embodiments, control information 606 is dynamically updated to change the operation to be performed by memory die processing circuits 404.

Although various functional blocks are used to describe memory die 400, in some embodiments, different and/or more functional blocks may be present. For example, in some embodiments, memory die 400 may include additional functional blocks for performing reads and writes, for refreshing data in the memory circuits 402, for verifying data, etc. Generally, memory die 400 includes sufficient functional blocks to perform the operations herein described and/or other operations.

In some embodiments, controller 304 in logic die 300 includes control information akin to control information 606 (i.e., control information stored and used as described above, but in controller 304). In these embodiments, logic die processing circuits 302 are configured to selectively perform two or more operations on data and the information in control information in controller 304 determines the particular operation that is to be performed.

### Arrangement of Dies

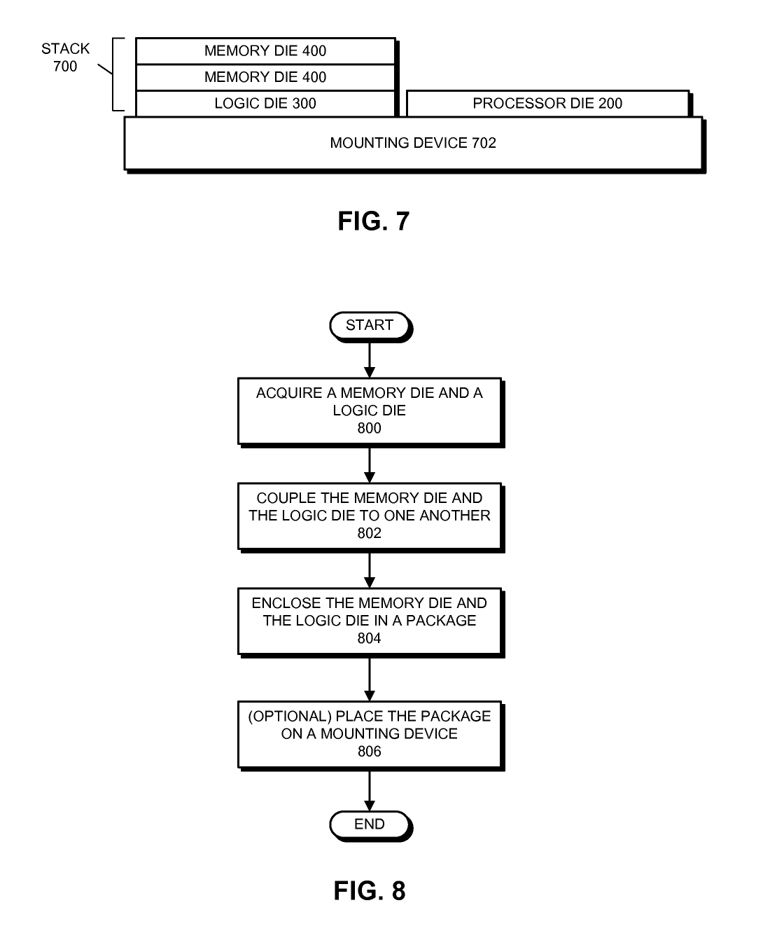

In some embodiments, the processor die 200, logic die 300, and memory die 400 are physically arranged with respect to one another (i.e., positioned, coupled, etc.) to enable the operations herein described. FIG. 7 presents a block diagram illustrating an arrangement of dies in accordance with some embodiments. As can be seen in FIG. 7, the arrangement of dies includes stack 700, which includes two memory dies 400 stacked on a logic die 300, and processor die 200. Stack 700 and processor die 200 are coupled beside each other on top of mounting device 702 (so that stack 700 is located on one side of processor die 200). Mounting device 702 is a mechanical mount for stack 700 and processor die 200. For example, mounting device 702 may be a substrate, an interposer, a circuit board, and/or a bracket to which stack 700 and processor die 200 are mounted using one or more of mechanical fasteners or holders (e.g., sockets, clamps, screws, etc.), chemical bonding agents (e.g., glues, solders, etc.), etc. Mounting device 702 includes one or more signal routes (e.g., buses, signal lines, etc.), active devices (e.g., repeaters, logic, etc.), and/or passive devices (e.g., discrete circuit elements, etc.) that are used to enable the dies to communicate with one another using electrical, optical, etc. signals.

In some embodiments, each of the dies in stack 700 are communicatively coupled to each other and/or to mounting device 702 to enable communication between the dies. For example, in some embodiments, the dies in stack 700 are communicatively coupled using through-silicon vias (TSVs), soldered connections, proximity connections (e.g., capacitive coupling, magnetic coupling, etc.), and/or other electrical, optical, etc. connections.

In some embodiments, one or more of stack 700 and processor die 200 are enclosed in packages. In these embodiments, the packages can be of any type that protect the enclosed dies, enable communication with the enclosed dies, etc.

Although an arrangement of dies for some embodiments is described, in some embodiments a different arrangement of dies is used. For example, in some embodiments, stack 700 is not used and/or is not configured as shown. For example, the memory dies 400 may not be stacked and instead may be arranged beside each other with only part of each memory die 400 overlapping a different portion of logic die 300. As another example, in some embodiments, all of the dies (or packages in which dies are enclosed) are arranged in a single layer on mounting device 702, with the other dies arranged to one or more sides of each die. Generally, the described embodiments may use any arrangement of dies that enables the operations herein described.

### Process for Assembling an Arrangement of Dies

FIG. 8 presents a flowchart illustrating a process for assembling an arrangement of dies in accordance with some embodiments. Note that the operations shown in FIG. 8 are presented as a general example of functions performed by some embodiments. The operations performed by other embodiments include different operations and/or operations that are performed in a different order. Additionally, although certain numbers and types of dies (i.e., memory die 400, logic die 300, etc.) are used in describing the process, in some embodiments, other numbers and types of dies may be used. For example, in some embodiments, two or more memory dies 400 may be assembled with a logic die 300.

As can be seen in FIG. 8, the process starts by acquiring a memory die 400 and a logic die 300 (step 800). For example, the memory die 400 and logic die 300 can be acquired from a semiconductor chip fabricator.

Next, the memory die 400 and logic die 300 are coupled to one another (step 802). For example, the memory die 400 and the logic die 300 coupled in a stack such as stack 700 with at least some portion of the dies overlapping, may be located next to each other, etc. During this operation, the dies may be physically located with respect to one another, such as aligning the dies with one another using one or more alignment mechanisms, placing the dies at a specified distance, angle, overlap, etc. with respect to one another, placing the dies on an interposer (which may include signal routes, active/inactive devices, etc.). and/or otherwise locating the dies with respect to one another. After locating the dies, the dies may be mechanically or chemically fastened in place using fasteners, spacers, frames, bonding agents, etc. In addition, communication connections/paths/etc. may be formed between the dies using techniques such as soldering, adjoining/aligning communication regions on the dies, etc. In some embodiments, the communication connections/paths/etc. (electrical, capacitive, optical, etc.) enable the communication of commands and data between the memory die 400 and the logic die 300 such as described herein.

The coupled dies are then enclosed in a package (step 804). Generally, enclosing the dies in a package includes placing the dies in a package that physically protects the dies and/or stabilizes the positions of the dies with respect to one another. In the described embodiments, any of various well-known package types can be used to enclose the dies. In some embodiments, the processor die described for step 806 is also enclosed in the package (i.e., along with the coupled dies), although the processor die may be in a separate package in other embodiments.

The package in which the dies are enclosed is then optionally placed on a mounting device such as mounting device 702 along with processor die 200 (step 806).

Performing Processing Operations in a Memory Die and/or a Logic Die

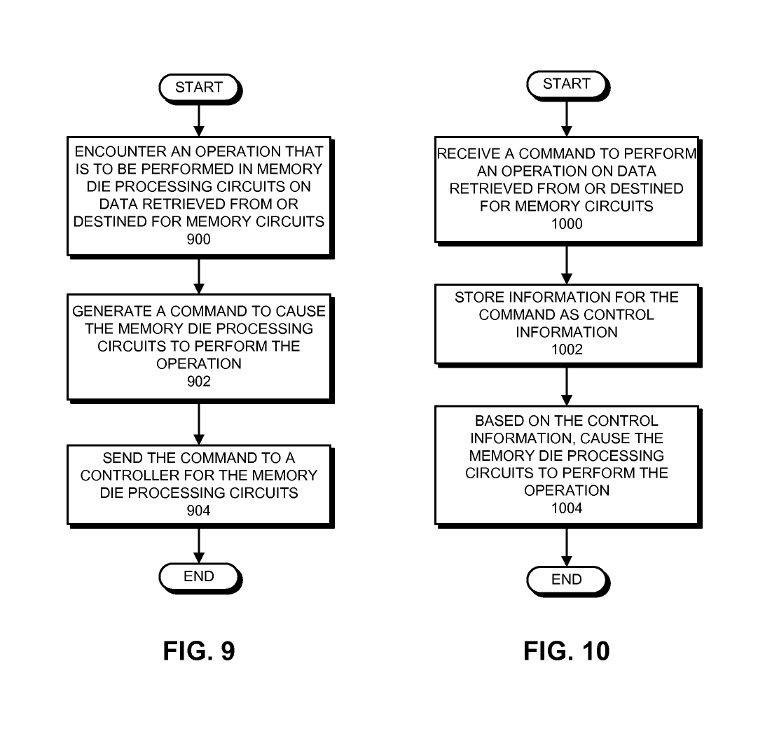

FIG. 9 presents a flowchart illustrating a process for sending a command to controller 406 from processor 102 in accordance with some embodiments. For the operations in FIG. 9, it is assumed that processor die 200 is coupled at least to memory die 400. Thus, processor 102 and controller 406 are arranged to communicate commands and data between one another as described above.

Note that the operations shown in FIG. 9 are presented as a general example of functions performed by some embodiments. The operations performed by other embodiments include different operations and/or operations that are performed in a different order. Additionally, although certain dies are used in describing the process, in some embodiments, other numbers and types of dies may be used.

The process shown in FIG. 9 starts when processor 102, while executing program code, encounters an operation that is to be performed by memory die processing circuits 404 on data retrieved from and/or destined for memory circuits 402 (step 900). For example, processor 102 can encounter an operation such as an increment, an addition, a matrix operation, and/or another operation to be performed for a set of specified portions (the portions being, e.g., 8-bit, 16-bit, 4-byte, 8-byte, etc. portions) of data retrieved from memory circuits 402 (e.g., 8192 bytes of data, 16384 bytes of data, etc.). As another example, processor 102 can encounter an operation to be performed for each of a set of specified portions of data that is destined for memory circuits 402. For the latter example, the encountered operation is to be performed by memory die processing circuits 404 on data that is/was sent from processor 102 and/or another functional block to memory die 400 before the data is written to memory circuits 402.

Processor 102 then generates a command to cause memory die processing circuits 404 to perform the operation (step 902). For example, processor 102 can generate an opcode, a command bit pattern, can acquire a program counter for an instruction for the operation, can retrieve the command from a specified memory location or a table, and/or can otherwise derive, create, or acquire the command.

Next, processor 102 sends the command to controller 406 (step 904). For example, after generating the command, processor 102 may send command 208, which is received as received command 412 by controller 406. Upon receiving the command, controller 406 performs the operation (or, rather, causes the operation to be performed by memory die processing circuits 404) for each of the set of specified portions of the data that is retrieved from or destined for memory circuits 402. In some embodiments, when performing the operation on data retrieved from memory circuits 402, memory die processing circuits 404 retrieves the data from memory circuits 402 (perhaps one row/column/portion at a time), performs the operation on the data, and then stores the data to memory circuits 402 and/or sends the data to another functional block. In some embodiments, when performing the operation on data destined for memory circuits 402, memory die processing circuits 404 receives the data as received data 408 from another functional block, performs the operation on the received data, and then stores the data in memory circuits 402 and/or sends the data to another functional block. In some embodiments, memory die processing circuits 404 performs operations on a combination of data retrieved from memory circuits 402 and received data 408. In these embodiments, memory die processing circuits 404 receives received data 408 from another functional block, retrieves additional data from memory circuits 402, performs the operation on some combination of the received and retrieved data, and stores the results in memory circuits 402 and/or returns the results to another functional block.

Note that, in existing systems, for data to be retrieved from memory circuits 402, performing these types of operation means loading as much of the data as possible at a time to processor 102 (which may be far less than the entire amount of data upon which the operation is to be performed) and performing the operation on each of the specified portions—thereby incurring delay and consuming electrical power, compute time, and communication bandwidth for processor 102 and controller 406. For data that is destined for memory circuits 402, although processor 102 has the data (and/or generates the data) performing the operations in processor 102 consumes compute time that may be used for performing other operations. In the described embodiments, however, because memory die 400 includes memory die processing circuits 404, such operations can be performed in memory die 400 instead of in processor 102.

FIG. 10 presents a flowchart illustrating a process for receiving a command in controller 406 in accordance with some embodiments. For the operations in FIG. 10, it is assumed that processor die 200 is coupled at least to memory die 400. Thus, processor 102 and controller 406 are arranged to communicate commands and data between one another as described above.

Note that the operations shown in FIG. 10 are presented as a general example of functions performed by some embodiments. The operations performed by other embodiments include different operations and/or operations that are performed in a different order. Additionally, although certain dies are used in describing the process, in some embodiments, other numbers and types of dies may be used.

The process in FIG. 10 starts when controller 406 receives a command from processor 102 to perform an operation on data retrieved from and/or destined for memory circuits 402 (step 1000). As described above, processor 102 can send the command upon encountering an operation that processor 102 determines is to be performed by memory die processing circuits 404. Controller 406 may receive this command as received command 412 from processor 102.

Controller 406 then stores information for the command as control information 606 (step 1002). As described above, this includes the storing the command (e.g., a bit sequence representing the command, an opcode, a program counter, a memory location in memory circuits 402 for the command, and/or other forms of command) and/or information derived from, about, or related to the command in a register, a memory location, etc. Generally, controller 406 can store information for the command in any form that can be recognized by controller 406 and that causes controller 406 to perform the corresponding operation (or, rather, cause the operation to be performed by memory die processing circuits 404).

Based on control information 606, controller 406 next causes memory die processing circuits 404 to perform the corresponding operation (step 1004). In some embodiments, when performing the operation on data retrieved from memory circuits 402, memory die processing circuits 404 retrieves the data from memory circuits 402 (perhaps one row/column/portion at a time), performs the operation on the data, and then returns the data to memory circuits 402 and/or sends the data to another functional block. In some embodiments, when performing the operation on data destined for memory circuits 402, memory die processing circuits 404 receives the data as received data 408 from another functional block, performs the operation on the received data, and then stores the data in memory circuits 402 and/or sends the data to another functional block. In some embodiments, memory die processing circuits 404 performs operations on a combination of data retrieved from memory circuits 402 and received data 408. In these embodiments, memory die processing circuits 404 receives received data 408 from another functional block, retrieves additional data from memory circuits 402, performs the operation on some combinations of the received and retrieved data, and stores the results in memory circuits 402 and/or returns the results to another functional block.

Note that, although embodiments are described in FIGS. 9-10 in which a single command is sent from processor 102 to controller 406, in some embodiments, two or more commands may be sent from processor 102 (and/or another functional block) to controller 406. In these embodiments, control information 606 may include information from multiple commands. In addition, in some embodiments, a single command may cause multiple separate operations to be performed in memory die processing circuits 404. In these embodiments, control information 606 may include a sequence of commands (sub-commands, etc.) based on a single command received from processor 102.

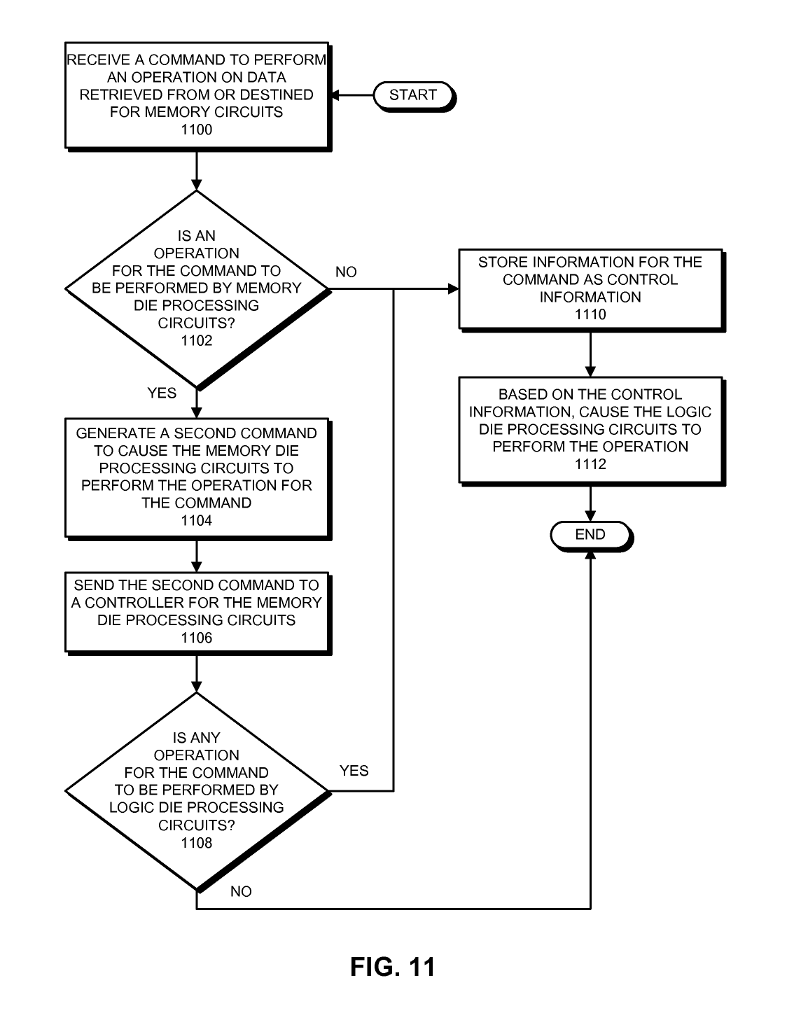

FIG. 11 presents a flowchart illustrating a process for handling a command in logic die 300 in accordance with some embodiments. For the operations in FIG. 11, it is assumed that processor die 200, logic die 300, and memory die 400 are coupled together as described above. Thus, processor 102, controller 304, and controller 406 are arranged to communicate commands and data between one another as described above.

Note that the operations shown in FIG. 11 are presented as a general example of functions performed by some embodiments. The operations performed by other embodiments include different operations and/or operations that are performed in a different order. Additionally, although certain dies are used in describing the process, in some embodiments, other numbers and types of dies may be used.

Generally, the process shown in FIG. 11 differs from the processes shown in FIGS. 9-10 in that controller 304, despite having received a command from processor 102 to perform an operation, may not perform some or all of the operation. Instead, controller 304 may extract a second command from the received command (or otherwise use the command received from processor 102 to generate a second command) and send the second command to controller 406 to cause an operation to be performed in memory die processing circuits 404. In this way, controller 304 offloads an operation (i.e., an operation that was already offloaded from processor 102) for the received command to controller 406.

The process in FIG. 11 starts when controller 304 receives a command from processor 102 to perform an operation on data retrieved from or destined for memory circuits 402 (step 1100). Processor 102 may send the command upon encountering an operation that processor 102 determines is to be performed by logic die processing circuits 302. Controller 304 may receive this command as received command 310 from processor 102.

Controller 304 then analyzes the command to determine if an operation for the command (which may be a sub-operation from a set of sub-operations for the command) is to be performed by memory die processing circuits 404 (step 1102). For example, controller 304 may preprocess (interpret, decompose, decode, etc.) the command to determine the operations to be performed, may look up the command in a table to determine the operations to be performed, may determine an amount of data to be retrieved from memory circuits 402 to perform the operations, and/or may otherwise process the command to determine the operations to be performed for the command. Controller 304 may then determine whether any operation for the command is to be performed in memory die processing circuits 404. In some embodiments, controller 304 is configured with a list, a table, and/or another indication of operations to be performed by memory die processing circuits 404. In some embodiments, controller 304 is configured so that the operations to be performed by memory die processing circuits 404 (instead of logic die processing circuits 302) include operations that are higher bandwidth (i.e., operations that have more than specified rates of data transfer from memory circuits 402) and/or are low-complexity.

If at least one operation for the command is to be performed by memory die processing circuits 404 (step 1102), controller 304 generates a second command to cause memory die processing circuits 404 to perform the operation (1104). For example, controller 304 can generate an opcode, a command bit pattern, can acquire a program counter for one or more instructions for the operation, can retrieve the command from a specified memory location or a table, and/or can otherwise derive, create, or acquire the second command. Note that the second command may include only a portion of the operation (or sub-operations) from the original command from processor 102 and/or controller 406 may use differently-formatted commands than controller 304, and thus the second command may be different than the original command.

Next, controller 304 sends the second command to controller 406 (step 1106). For example, after generating the command, controller 304 may send command 312, which is received as received command 412 by controller 406. Upon receiving the command, controller 406 performs the operation (or, rather, causes the operation to be performed by memory die processing circuits 404) for the data that is retrieved from or destined for memory circuits 402. In some embodiments, when performing the operation on data retrieved from memory circuits 402, memory die processing circuits 404 retrieves the data from memory circuits 402 (perhaps one row/column/portion at a time), performs the operation on the data, and then returns the data to memory circuits 402 and/or sends the data to another functional block. In some embodiments, when performing the operation on data destined for memory circuits 402, memory die processing circuits 404 receives the data as received data 408 from another functional block, performs the operation on the received data, and then stores the data in memory circuits 402 and/or sends the data to another functional block. In some embodiments, memory die processing circuits 404 performs operations on a combination of data retrieved from memory circuits 402 and received data 408. In these embodiments, memory die processing circuits 404 receives received data 408 from another functional block, retrieves additional data from memory circuits 402, performs the operation on some combinations of the received and retrieved data, and stores the results in memory circuits 402 and/or returns the results to another functional block.

Controller 304 then determine if an operation for the command is to be performed by logic die processing circuits 302 (step 1108). If not, the process is complete (because the second command replaces the original command and the entire operation for the original command is performed by memory die processing circuits 404). Otherwise (step 1108), or if an operation for the command is not to be performed by memory die processing circuits 404 (step 1102), controller 304 stores information for the command as control information in controller 304 (1110). As described above, this includes storing the command (e.g., a bit sequence representing the command, an opcode, a program counter, a memory location for the command, and/or other forms of command) and/or information derived from, about, or related to the command in a register, a memory location, etc. Generally, controller 304 can store information for the command in any form that can be recognized by controller 304 and that causes controller 304 to perform the corresponding operation.

Based on the control information, controller 304 next causes logic die processing circuits 302 to perform the corresponding operation (step 1112). In some embodiments, when performing the operation on data retrieved from memory circuits 402, logic die processing circuits 302 sends a request to memory circuits 402 to retrieve the data from memory circuits 402 (perhaps one block at a time), performs the operation on the retrieved data, and then sends the data back to memory circuits 402 for storage therein. In some embodiments, when performing the operation on data destined for memory circuits 402, logic die processing circuits 302 receives the data as received data 306 from another functional block, performs the operation on the received data, and then sends the data to memory circuits 402 for storage therein.

Note that, although embodiments are described in FIG. 11 in which a single command is received in controller 304, in some embodiments, two or more commands may be received by controller 304 (i.e., sent from processor 102 and/or another functional block to controller 304). In these embodiments, the control information in controller 304 may include information from multiple commands. In addition, in some embodiments, a single command may cause multiple separate operations to be performed in logic die processing circuits 302 and/or memory die processing circuits 404. In these embodiments, the control information in controller 304 may include a sequence of commands (sub-commands, etc.) based on a single command received from processor 102. In these embodiments, some or all of the sub-commands may be sent to controller 406 as described above.

In some embodiments, a computing device (e.g., computing device 100 in FIG. 1 and/or some portion thereof) uses code and/or data stored on a computer-readable storage medium to perform some or all of the operations herein described. More specifically, the computing device reads the code and/or data from the computer-readable storage medium and executes the code and/or uses the data when performing the described operations.

A computer-readable storage medium can be any device or medium or combination thereof that stores code and/or data for use by a computing device. For example, the computer-readable storage medium can include, but is not limited to, volatile memory or non-volatile memory, including flash memory, random access memory (eDRAM, RAM, SRAM, DRAM, DDR, DDR2/DDR3/DDR4 SDRAM, etc.), read-only memory (ROM), and/or magnetic or optical storage mediums (e.g., disk drives, magnetic tape, CDs, DVDs). In the described embodiments, the computer-readable storage medium does not include non-statutory computer-readable storage mediums such as transitory signals.

In some embodiments, one or more hardware modules are configured to perform the operations herein described. For example, the hardware modules can comprise, but are not limited to, one or more processors/cores/central processing units (CPUs), application-specific integrated circuit (ASIC) chips, field-programmable gate arrays (FPGAs), caches/cache controllers, compute units, embedded processors, graphics processors (GPUs)/graphics cores, pipelines, Accelerated Processing Units (APUs), and/or other programmable-logic devices. When such hardware modules are activated, the hardware modules perform some or all of the operations. In some embodiments, the hardware modules include one or more general-purpose circuits that are configured by executing instructions (program code, firmware, etc.) to perform the operations.

In some embodiments, a data structure representative of some or all of the structures and mechanisms described herein (e.g., computing device 100 and/or some portion thereof) is stored on a computer-readable storage medium that includes a database or other data structure which can be read by a computing device and used, directly or indirectly, to fabricate hardware comprising the structures and mechanisms. For example, the data structure may be a behavioral-level description or register-transfer level (RTL) description of the hardware functionality in a high level design language (HDL) such as Verilog or VHDL. The description may be read by a synthesis tool which may synthesize the description to produce a netlist comprising a list of gates/circuit elements from a synthesis library that represent the functionality of the hardware comprising the above-described structures and mechanisms. The netlist may then be placed and routed to produce a data set describing geometric shapes to be applied to masks. The masks may then be used in various semiconductor fabrication steps to produce a semiconductor circuit or circuits corresponding to the above-described structures and mechanisms. Alternatively, the database on the computer accessible storage medium may be the netlist (with or without the synthesis library) or the data set, as desired, or Graphic Data System (GDS) II data.

In the following description, functional blocks may be referred to in describing some embodiments. Generally, functional blocks include one or more interrelated circuits that perform the described operations. In some embodiments, the circuits in a functional block include circuits that execute program code (e.g., microcode, firmware, applications, etc.) to perform the described operations.

The foregoing descriptions of embodiments have been presented only for purposes of illustration and description. They are not intended to be exhaustive or to limit the embodiments to the forms disclosed. Accordingly, many modifications and variations will be apparent to practitioners skilled in the art. Additionally, the above disclosure is not intended to limit the embodiments. The scope of the embodiments is defined by the appended claims.

What is claimed is:

1. A computing device, comprising:
at least one memory die comprising memory circuits and memory die processing circuits; and
a logic die coupled to the at least one memory die, the logic die comprising logic die processing circuits;
wherein the memory die processing circuits are configured to perform memory die processing operations on data retrieved from or destined for the memory circuits; and
wherein the logic die processing circuits are configured to perform logic die processing operations on data retrieved from or destined for the memory circuits.

2. The computing device of claim 1, further comprising:
a processor die comprising a processor, wherein the processor die is coupled to the at least one memory die and the logic die;
wherein the processor is configured to send commands to at least one of the memory die processing circuits and the logic die processing circuits, the commands causing the at least one of the memory die processing circuits to perform at least one of the memory die processing operations and the logic die processing circuits to perform at least one of the logic die processing operations.

3. The computing device of claim 2, wherein the logic die processing circuits are further configured to:
extract at least one command from the commands received from the processor; and
forward the extracted command to the at least one memory die as the commands from the processor that cause the memory die processing circuits to perform the memory die processing operations.

4. The computing device of claim 2, wherein the at least one memory die is coupled in a stack with the logic die.

5. The computing device of claim 4, further comprising:
a mounting device;
wherein the stack and the processor die are coupled to the mounting device so that the processor die is located beside the stack.

6. The computing device of claim 2, wherein at least one of the memory die processing circuits and the logic die processing circuits are each configured to perform a corresponding predetermined subset of operations that the processor is configured to perform.

7. The computing device of claim 2, wherein the at least one memory die further comprises:
a command memory element;
wherein, when sending a command to the memory die processing circuits, the processor is configured to write one or more corresponding values into the command memory element; and
wherein the memory die processing circuits are configured to interpret the one or more corresponding values to determine the command.

8. The computing device of claim 2, wherein the logic die further comprises:
a command memory element;
wherein, when sending a command to the logic die processing circuits, the processor is configured to write one or more corresponding values into the command memory element; and
wherein the logic die processing circuits are configured to interpret the one or more corresponding values to determine the command.

9. The computing device of claim 2, wherein, when sending commands to the memory die processing circuits or the logic die processing circuits, the processor is configured to:
send a program counter to the memory die processing circuits or the logic die processing circuits, the program counter indicating a location from where one or more instructions are retrieved for execution by the at least one of the memory die processing circuits and the logic die processing circuits, the instructions causing the at least one of the memory die processing circuits to perform at least one of the memory die processing operations and the logic die processing circuits to perform at least one of the logic die processing operations.

10. The computing device of claim 1, wherein the logic die processing circuits are further configured to:
send commands to the memory die processing circuits that cause the memory die processing circuits to perform at least one of the memory die processing operations.

11. The computing device of claim 1, wherein at least one of the memory die processing operations and the logic die processing operations comprise single-instruction-multiple-data operations.

12. A memory die, comprising:
memory circuits;
a controller; and
memory die processing circuits;
wherein the memory die is configured to be coupled in a hierarchical processing arrangement with at least one of a logic die and a processor die; and
wherein the controller is configured to cause the memory die processing circuits to perform memory die processing operations on data retrieved from or destined for the memory circuits based on a command received from the logic die or the processor die.

13. The memory die of claim 12, further comprising:
a command memory element in the memory die;
wherein the controller is configured to store information related to one or more commands received from the logic die or the processor die to the command memory element; and
wherein, when causing the memory die processing circuits to perform memory die processing operations, the controller is configured to cause the memory die processing circuits to perform the memory die processing operations based on information related to the one or more commands from the command memory element.

14. The memory die of claim 12, wherein, when performing memory die processing operations on data retrieved from the memory circuits, the memory die processing circuits are configured to:
retrieve the data from the memory circuits;
perform the memory die processing operations on data in the memory die processing circuits based on the command received from the logic die or the processor die; and
after performing the operations on the data, at least one of:
storing the data in the memory circuits; and
sending the data to the logic die or the processor die.

15. The memory die of claim 12, wherein, when performing memory die processing operations on data destined for the memory circuits, the memory die processing circuits are configured to:
receive the data from a functional block external to the memory die;
perform the memory die processing operations on data in the memory die processing circuits based on the command received from the logic die or the processor die; and
after performing the operations on the data, at least one of:
storing the data to the memory circuits; and
sending the data to the logic die or the processor die.

16. A logic die, comprising:
a controller; and
logic die processing circuits;
wherein the logic die is configured to be coupled in a hierarchical processing arrangement with at least one of a memory die and a processor die; and
wherein the controller is configured to cause the logic die processing circuits to perform logic die processing operations on data retrieved from or destined for memory circuits in a memory die based on a command received from the processor die or the memory die.

17. The logic die of claim 16, further comprising:
a command memory element in the logic die;
wherein the controller is configured to store information related to one or more commands received from the processor die or the memory die to the command memory element; and
wherein, when causing the logic die processing circuits to perform logic die processing operations, the controller is configured to cause the logic die processing circuits to perform the logic die processing operations based on information related to the one or more commands from the command memory element.

18. The logic die of claim 16, wherein, when performing logic die processing operations on data retrieved from or destined for the memory circuits, the logic die processing circuits are configured to:
receive the data from a functional block external to the logic die;
perform the logic die processing operations on the data based on the command received from the processor die or the memory die; and
after performing the operations on the data, at least one of:
sending the data to a memory die to be stored in the memory circuits; or
sending the data to a functional block external to the logic die.

19. The logic die of claim 16, wherein the controller is further configured to:
extract a second command from a command received from the processor die, the second command configured to cause memory die processing circuits in the memory die to perform corresponding memory die processing operations on data retrieved from or destined for the memory circuits; and
send the second command to the memory die.

20. A method for performing processing operations in a computing device that comprises a memory die coupled to a logic die, the method comprising:
in one or more of memory die processing circuits on the memory die and logic die processing circuits on the logic die, performing processing operations on data retrieved from or destined for memory circuits in the memory die;
wherein performing the processing operations on the data comprises performing the processing operations based on a hierarchical arrangement of processing operations in which specified processing operations are performed in the memory die processing circuits and other processing operations are performed in the logic die processing circuits.

21. The method of claim 20, further comprising:
in a processor, performing processing operations on data retrieved from or destined for memory circuits in the memory die;
wherein performing the processing operations on the data in the processor comprises performing the processing operations based on the hierarchical arrangement of processing operations in which some processing operations are performed in the memory die processing circuits and the logic die processing circuits, and other processing operations are performed in the processor.

22. The method of claim 21, further comprising:
in the logic die processing circuits, receiving a command from the processor or the memory die processing circuits, the command configured to cause the logic die processing circuits to perform corresponding processing operations on the data.

23. The method of claim 22, further comprising:
in the logic die processing circuits, extracting a second command from the received command and sending the extracted command to the memory die processing circuits, the command configured to cause the memory die processing circuits to perform corresponding processing operations on the data.

24. The method of claim 22, further comprising:
in the logic die processing circuits, storing information from the command as control information and, based on the stored control information, configuring the logic die processing circuits to perform the processing operations.

25. The method of claim 21, further comprising:
in the memory die processing circuits, receiving a command from the processor or the logic die processing circuits, the command configured to cause the memory die processing circuits to perform corresponding processing operations on the data.

26. The method of claim 25, further comprising:
in the memory die processing circuits, storing information from the command as control information and, based on the stored control information, configuring the memory die processing circuits to perform the processing operations.

27. The method of claim 20, wherein, in the hierarchical arrangement of processing operations, one or both of higher-bandwidth and lower-complexity processing operations are performed in the memory die processing circuits and one or both of lower-bandwidth and higher-complexity operations are performed in the logic die processing circuits.
